(19) United States
(12) Patent Application Publication
(10) Pub. No.: US 2026/0316850 A1
(43) Pub. Date: Oct. 15, 2026

(54) Vehicle Mounted Tire Storage Rack

(71) Applicant: Gary James Orman, Jr., Yonkers, NY (US)

(72) Inventor: Gary James Orman, Jr., Yonkers, NY (US)

(21) Appl. No.: 19/176,028

(22) Filed: Apr. 10, 2025

(51) Int. Cl. B62D 43/02; B62D 65/16

(52) U.S. Cl. CPC B62D 43/02; B62D 65/16

(57) ABSTRACT

The present invention relates to an adjustable tire rack designed for use with the bed of a pickup truck. The tire rack is configurable in both length and width to accommodate a variety of tire sizes, making it versatile for different applications. The rack spans the truck bed opening, creating a substantially planar surface on which tires can be securely placed during transportation. The tire rack incorporates an adjustable longitudinal gap, allowing for the accommodation of tires with varying circumferences. This innovative design provides an efficient, customizable solution for transporting tires of different sizes in a secure and stable manner.

### CROSS-REFERENCE TO RELATED APPLICATIONS

This patent application claims the benefit of U.S. Provisional Patent Application 63/633,164 filed on Apr. 12, 2024 which is hereby incorporated by reference herein in its entirety.

### BACKGROUND OF THE INVENTION

For those participating in motorsports, one significant consumable is tires. There are tires for different types of surfaces (e.g., road or dirt), for use in different conditions (e.g. wet or dry), tires of various different sizes, and spare sets of the foregoing as tires do wear out relatively quickly. A participant may need to bring several sets of tires to a single race day or race weekend. Thus, a problem with tires is often just transporting sufficient numbers of them to the race track. Many solutions are used including various forms of tire racks attached to trailers. A goal is often to transport as many tires as practical safely to the track without taking up too much space which may be needed and/or utilized for other racing related items.

### SUMMARY OF THE INVENTION

### Summary of the Invention

The present invention relates generally to storage systems for vehicles, and more particularly to an adjustable tire rack configured for attachment to a truck bed.

In one aspect, the invention provides a storage rack comprising a base adapted for attachment to a truck bed, and at least one adjustable member configured to permit the rack to be resized to fit the dimensions of the truck bed. In certain embodiments, the rack is specifically adapted to store and secure tires.

In various embodiments, the storage rack includes a plurality of vertical uprights pivotally connected to the base. The uprights may be secured using hinges or foldable joints, allowing the rack to be collapsed into a substantially flat position for storage or transport. The rack may achieve a collapsed height of less than approximately four inches.

The adjustable member(s) may permit the rack to be modified in one or more directions, including width, height, and length, in order to accommodate various truck bed sizes and tire configurations. Adjustment mechanisms may include width adjustment features that enable lateral expansion beyond the width of the truck bed. The rack may be further configured to support multiple tires stacked either horizontally or vertically.

In certain embodiments, the tire rack includes a quick-latch securing mechanism, such as lynchpin locking elements, to enable tool-less adjustment and securement of the rack. The adjustment features may be configured for single-person operation. The rack may also be mountable at multiple positions along the truck bed, including toward the cab, the tailgate, or an intermediate location.

The invention further provides a method for installing the tire rack, the method including steps of attaching the base to the truck bed, attaching and securing the vertical uprights, and adjusting the rack to accommodate both the truck bed and the intended tire load. The method may further include collapsing the rack for storage and adjusting one or more components to fit different tire sizes, types, or orientations.

In certain embodiments, the rack is compatible with existing truck bed accessories, such as tonneau covers, allowing for simultaneous use without interference.

### BRIEF DESCRIPTION OF DRAWINGS

FIG. 1 depicts the tire rack of the present invention in a folded state; while FIG. 2 depicts the tire rack of the present invention in an assembled state.

### DETAILED DESCRIPTION OF THE INVENTION

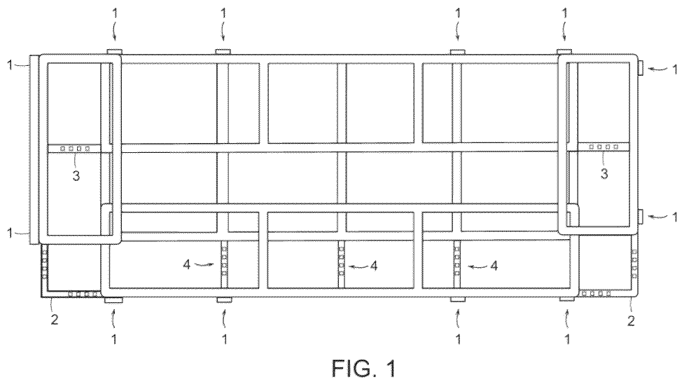

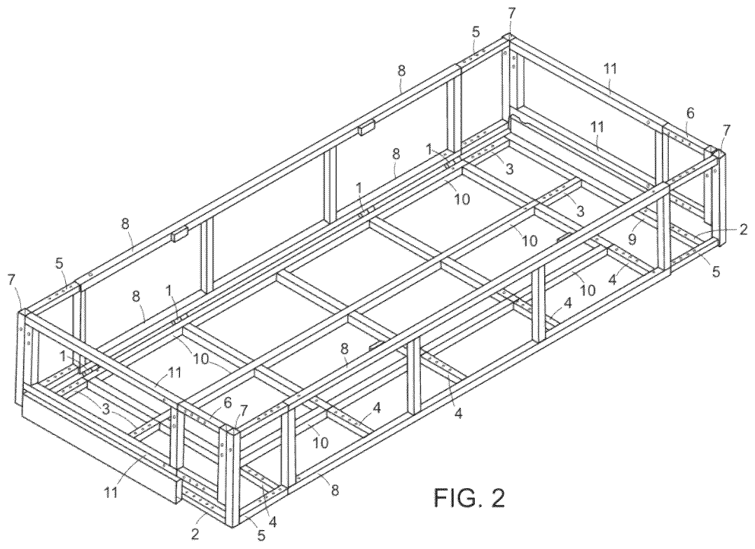

FIG. 2 shows how a tire rack according to the present invention and including a base and collapsible sides may adjust outward and inward in width and depth and height, as depicted by the dashed lines. FIG. 1 provides a visual representation of the adjustability, indicating the direction and extent to which the components will extend to accommodate varying dimensions. This adjustability demonstrates the extent to which the design may be adapted to different storage requirements and adjustments.

The present invention comprises an adjustable tire rack for use in association with the bed of a pickup truck. The tire rack is adjustable as to overall length and gap in width to accommodate a variety of tire sizes. The overall rack is designed to bridge the truck bed opening providing a substantially planar surface to receive the tires being transported. The planar surface (referred to herein as the bridge) has a longitudinal gap in it of adjustable size to accommodate different circumference tires.

One commercial example of a bed rack for providing a substantially planar mounting surface for the Tire Rack of the present invention is available from Amazon.com per the link hereinbelow.
Universal Truck Bed Rack with 2 Steel Board, SYHVU Adjustable Multi-Function Design Rack Cross Board, Fit for Dodge
Ram, F-150/F-250/F-350, Silverado, Sierra, Sonoma, Canyon, Nissan Titan, Nissan Frontier: Automotive

Turning to FIG. 1, the tire rack of the present invention essentially forms a two level rack when assembled. Pivotal connections 1 allows rotation around a fixed axis in order to raise or lower all four side walls of the adjustable second-level tire rack to the truck bed.

One or more mounting interfaces are also included and are positioned at the ends of the fixed base or at the adjusted ends of the base. Each of the mounting interfaces is configured to operably couple the frame assembly to the bed rails of the pickup truck via an aftermarket clamping system or bridge mounting system, both of which are commercially available from suppliers (in one example, the Interface could comprise The Amazon.com product discussed hereinabove). The mounting interfaces are structurally independent from any particular clamping system, thereby enabling attachment using a variety of commercially available mounting solutions.

Mechanical joint 2 facilitates sliding and locking of tire rack components using a series of predefined holes adapted to receive a locking lynchpin. A 90-degree adjustable insertable tube connector designed to be inserted into another tube along the X and Y axes to connect two planes while allowing width or depth adjustments.

An insertable adjustable tube 3 includes defined adjustment holes for a locking lynchpin. A telescoping mechanism allows the width of a tire rack (along the X-axis) to be adjusted. This element provides both structural support and adjustability, ensuring the rack can accommodate different tire sizes.

An insertable adjustable tube 4 includes defined adjustment holes for a locking lynchpin. A telescoping mechanism allows the depth of a tire rack (along the Y-axis) to be adjusted. This element provides both structural support and adjustability, ensuring the rack can accommodate different tire sizes.

Turning to FIG. 2, the tire rack includes an insertable adjustable tube 5 with defined adjustment holes adapted to receive a locking lynchpin. A telescoping mechanism allows the width of the vertical upright of the adjustable tire rack (along the X-axis) to be adjusted. This element provides structural support, containment, and adjustability, ensuring the rack can accommodate different tire sizes securely.

An insertable adjustable tube 6 with defined adjustment holes is adapted to receive a locking lynchpin. A telescoping mechanism that allows the depth of the vertical upright of the tire rack (along the Y-axis) to be adjusted. This element provides structural support, containment, and adjustability, ensuring the rack can accommodate different tire sizes securely.

An open end 7 of an outer tube of the end of the front and rear end caps of the collapsable upright allows the inner tube of additional devices such as extendable vertical uprights to extend the height of each side or to accept various aftermarket devices like a webbed net to additionally secure the contents of the adjustable tire rack.

An outer tube 8 of the front and rear vertical uprights, receives the inner adjustable tube with defined holes for adjusting the width.

An outer tube 9 on each side of the base, receives the 90-degree adjustable insertable tube connector 2 to allow for adjustability of the depth.

An outer tube 10 of the base is designed to receive inner tube 3 to adjust the width of the adjustable tire rack.

An outer tube 11 of the collapsable side vertical uprights, which receives the inner adjustable tube 6 with defined holes for adjusting the depth.

The adjustable tire rack is designed to mount on the bed rails of a pickup truck using commercially available mounting brackets, clamps or bridge systems. These devices allow the adjustable rack to maintain a low-profile footprint, making it universally adaptable to most pickup truck existing bed covers.

The platform can be adjustable in width or depth of the perimeter sides and adapt additional sections to increase the height enough to accommodate at least two tires laid flat (horizontal) or upright (vertical).

As the adjustment mechanisms either uses telescoping tubing, raised lower sides and/or the use of lynchpins which are configured to adjust the racks dimensions with no use of additional people for single-person operation with minimal effort. That is, a single user can adjust the racks dimensions without a second person, or excessive force.

The adjusted for size rack will lock into place at predefined dimensions using locking lynchpin devices, thus not requiring additional tools. The present invention may utilize various materials with their respective design characteristics and in the construction of the tire rack. Such materials may include metals such as aluminum and/or steel and may further comprise extruded common shape members such as round and/or square tubing. As a finish, commonly used metal finishing techniques such as anodization, painting, and powder coat techniques may be used. The choice of particular materials and characteristics will be apparent to one of ordinary skill in the art.

1. A storage rack for attachment to a vehicle, said vehicle including a truck bed, said storage rack comprising:
a base, said base adapted for attachment to said truck bed;
at least one adjustable member, wherein said at least one adjustable member may be sized such that said storage rack fits the truck bed.

2. The storage rack of claim 1 wherein said storage rack is adapted to hold tires.

3. The storage rack of claim 2, wherein said storage rack is adjustable in at least one direction to fit within the vehicle.

4. The storage rack of claim 2 wherein said storage rack is adjustable in at least one direction to fit a particular tire.

5. The storage rack of claim 4, wherein said at least one direction comprises at least one of tire height, tire circumference, tire type, and rack height.

6. The storage rack of claim 4 wherein said at least one direction comprises width.

7. The storage rack of claim 4 wherein said at least one direction comprises length.

8. The storage rack of claim 4 wherein said at least one direction comprises height.

9. A method for installing a tire rack, said tire rack comprising a storage rack for attachment to a vehicle, said vehicle including a truck bed, said method comprising the steps of:
a. attaching said tire rack to said truck bed;
b. attaching said vertical uprights to said base;
c. securing said vertical uprights in place using hinges and at least a pair of vertical uprights.

10. The method of claim 9 wherein said securing comprises securing said vertical uprights in place using hinges and at least a two pair of vertical uprights.

11. The tire rack of claim 9 wherein said tire rack includes at least one adjustable member, and wherein said method further comprising the step of resizing said adjustable member such that said storage rack fits the truck bed.

12. The method of claim 9, further including the steps of adjusting said storage rack to hold tires.

13. The method of claim 7, further comprising adjusting said tire rack in said at least one direction to fit within the vehicle.

14. A tire rack comprising:
a base;
a plurality of vertical uprights, said vertical uprights being pivotally attached to said base; wherein said tire rack further comprises a width adjustment mechanism, said width adjustment mechanism permits said tire rack to fit a truck bed of a vehicle.

15. The tire rack of claim 14, further comprising a collapsing mechanism, wherein the collapsing mechanism comprises foldable joints coupling said base to said vertical uprights.

16. The tire rack of claim 15 wherein said tire rack collapses into a substantially flat closed position with a height of less than 4 inches.

17. The tire rack of claim 16, wherein the upper platform is configured to support multiple tires stacked horizontally or vertically.

18. The tire rack of claim 14, further comprising a quick-latch securing mechanism that allows for at least on of tool-less adjustment and locking.

19. The tire rack of claim 18 wherein said quick-latch comprises lynchpin locking mechanisms.

20. The tire rack of claim 14, wherein the width adjustment is adapter to permit the platform to expand laterally beyond the width of the truck bed.

21. The tire rack of claim 20, wherein the rack can be mounted in various positions along the truck bed, whether it be towards the truck cab, tailgate, or midship.
